(19) United States
(12) Patent Application Publication
(10) Pub. No.: US 2024/0348576 A1
(43) Pub. Date: Oct. 17, 2024

(54) ACCESS SYSTEM FOR INTERNET OF THINGS TERMINAL, METHOD, APPARATUS, AND STORAGE MEDIUM

(71) Applicant: E SURFING IOT CO., LTD., Guangzhou, Guangdong (CN)

(72) Inventors: Zhonglei LI, Guangzhou, Guangdong (CN); Feng CHEN, Guangzhou, Guangdong (CN); Xiao SHI, Guangzhou, Guangdong (CN); Cheng WANG, Guangzhou, Guangdong (CN); Xiangbin KONG, Guangzhou, Guangdong (CN); Zhuorui LAN, Guangzhou, Guangdong (CN); Yang CHEN, Guangzhou, Guangdong (CN)

(21) Appl. No.: 18/682,597

(22) PCT Filed: Dec. 22, 2021
(86) PCT No.: PCT/CN2021/140439

§ 371 Date: Feb. 9, 2024

(30) Foreign Application Priority Data
Aug. 11, 2021 (CN) 202110920957.8

(51) Int. Cl. H04L 61/2503; G16Y 10/75; H04L 9/40

(52) U.S. Cl. CPC H04L 61/2503; G16Y 10/75; H04L 63/0272

(57) ABSTRACT

An access system for an Internet of Things terminal includes a core network gateway device and an IoT cloud platform, which communicate with each other through a first VPN. The core network gateway device is configured for allocating a first IP address to an IoT terminal, establishing an IoT terminal address pool according to the first IP address, and sending the IoT terminal address pool to the IoT cloud platform. Further, the IoT cloud platform is configured for receiving and storing the IoT terminal address pool, when a first message of a downlink instruction is received, obtaining the first IP address according to the first message and the IoT terminal address pool, and packaging the first message and the first IP address into a second message to be sent to the core network gateway device.

### TECHNICAL FIELD

The present disclosure relates to the technical filed of Internet of Things, and particularly to an access system for an Internet of Things terminal, method and apparatus and a storage medium.

### BACKGROUND

The arrow band Internet of Things (NB-IoT) network service refers to a NB-IoT cellular mobile communication network based on China Telecom for realizing communication between things and communication between things and people. The NB-IoT is established on a cellular network, has a bandwidth of 180 KHz, and is suitable for a reporting service with a small data packet and a long reporting period due to the network characteristic. However, with the development of the network service of the NB-IoT, applications in human-computer interaction scenarios represented by white household appliances have gradually emerged, such as shared washing machines and shared air conditioners, where the demand for instruction issuance is high. Traditional Internet of Things data transmission involves an Internet of Things terminal directly accessing a server established by a client. In this scenario, network address translation needs to be carried out by a core network before the Internet of Things terminal accesses the network, that is, a source IP address is mapped to a public network address before the access to the Internet. However, the NAT (Network Address Translation) has a keep-alive time limit, which is generally 120 seconds for UDP and 1,200 seconds for TCP. If a NAT session is released, the client server cannot send an instruction to the Internet of Things terminal. Therefore, a solution of the client involves the Internet of Things terminal sending a heartbeat message at intervals to keep the mapping of the NAT session. On one hand, this method causes occupation of a high amount of wireless bandwidth resources, which is easy to cause network congestion, and on the other hand, energy consumption for a battery-powered terminal is high, which cannot guarantee a service life of the terminal.

### SUMMARY

In order to solve at least one of the above technical problems, the present disclosure provides an access system for an Internet of Things terminal, method and apparatus and a storage medium, which can reduce the occupation of terminal heartbeat data on wireless network resources, improve a network capacity; and reduce the power consumption of a terminal.

In one aspect, an embodiment of the present disclosure provides an access system for an Internet of Things terminal, which comprises a core network gateway device and an Internet of Things cloud platform, wherein the core network gateway device and the Internet of Things cloud platform communicate with each other through a first virtual private network:
the core network gateway device is configured for allocating a first IP address to an Internet of Things terminal, establishing an Internet of Things terminal address pool according to the first IP address, and sending the Internet of Things terminal address pool to the Internet of Things cloud platform; and
the Internet of Things cloud platform is configured for receiving and storing the Internet of Things terminal address pool, when a first message of a downlink instruction is received, obtaining the first IP address according to the first message and the Internet of Things terminal address pool, and packaging the first message and the first IP address into a second message to be sent to the core network gateway device.

In some embodiments, the access system for an Internet of Things terminal further comprises a firewall, though which the core network gateway accesses the first virtual private network.

In some embodiments, the access system for an Internet of Things terminal further comprises a core network address mapping device configured for acquiring an uplink message of the Internet of Things terminal, parsing the uplink message to obtain the first IP address, Internet of Things data and a destination IP address, mapping the destination IP address into a second IP address, and packaging the first IP address, the Internet of Things data, the destination IP address and the second IP address into a third message.

In some embodiments, the second message comprises the first IP address, user instruction data and a second IP address of a virtual server of the Internet of Things cloud platform.

In some embodiments, the access system for an Internet of Things terminal further comprises a core network user edge router, the first virtual private network is a CN2 VPN, the core network user edge router is configured with a CN2 VPN network interface, and the core network gateway device accesses the CN2 VPN through the core network user edge router; and
the core network user edge router is configured for receiving a virtual server address pool on the Internet of Things cloud platform through a BGP, wherein the virtual server address pool comprises a plurality of second IP addresses.

In some embodiments, the access system for an Internet of Things terminal further comprises a cloud platform user edge router configured for receiving the Internet of Things terminal address pool through the BGP, wherein the Internet of Things terminal address pool comprises a plurality of first IP addresses.

In some embodiments, the core network gateway device communicates with the Internet of Things cloud platform through a second virtual private network:
the core network gateway device is further configured for generating a radius session message, and the radius session message is configured for characterizing a state of the Internet of Things terminal; and
the Internet of Things cloud platform is further configured for receiving the radius session message through the second virtual private network, and identifying the state of the Internet of Things terminal according to the radius session message.

In a second aspect, an embodiment of the present disclosure further provides an access method for an Internet of Things terminal, which is applied to the Internet of Things cloud platform of the access system for an Internet of Things terminal in the first aspect, wherein the access method for an Internet of Things terminal comprises:
receiving and storing the Internet of Things terminal address pool:
when the first message of the downlink instruction is received, obtaining the first IP address of the Internet of Things terminal according to the first message and the Internet of Things terminal address pool; and packaging the first message and the first IP address into the second message to be sent to the core network gateway device.

In a third aspect, an embodiment of the present disclosure further provides an Internet of Things terminal access apparatus, which comprises:
at least one processor; and at least one memory for storing at least one program:
wherein the at least one program, when executed by the at least one processor, causes the at least one processor to implement the access method for an Internet of Things terminal in the first aspect.

In a fourth aspect, an embodiment of the present disclosure further provides a computer storage medium, which stores a program executable by a processor, wherein the program executable by the processor, when executed by the processor, implements the access method for an Internet of Things terminal in the first aspect above.

The above technical solution of the present disclosure has at least one of the following advantages or beneficial effects. In the present disclosure, the first virtual private network is between the core network gateway device and the Internet of Things cloud platform. The core network gateway device is configured for allocating the first IP address to the Internet of Things terminal, establishing the Internet of Things terminal address pool according to the first IP address, and sending the Internet of Things terminal address pool to the Internet of Things cloud platform. The Internet of Things cloud platform is configured for receiving and storing the Internet of Things terminal address pool, when the first message of the downlink instruction is received, obtaining the first IP address according to the first message and the Internet of Things terminal address pool, and packaging the first message and the first IP address into the second message to be sent to the core network gateway device. After the Internet of Things terminal is attached to and accesses the network through the core network gateway device, the Internet of Things terminal uniformly accesses the Internet of Things cloud platform, and the Internet of Things cloud platform stores the Internet of Things terminal address pool, and after a downlink instruction message of a client is received, source address mapping is carried out on the Internet of Things cloud platform to obtain the first IP address of the Internet of Things terminal, thus completing the routing of the downlink instruction message. The source address mapping does not need to be carried out on the core network gateway, which can reduce the occupation of terminal heartbeat data on wireless network resources, improve a network capacity, and reduce the power consumption of a terminal.

### BRIEF DESCRIPTION OF THE DRAWINGS

FIG. 1 is a schematic diagram of an access system for an Internet of Things terminal provided by an embodiment of the present disclosure;

FIG. 2 is a schematic diagram of an access system for an Internet of Things terminal provided by another embodiment of the present disclosure:

FIG. 3 is a schematic diagram of an access system for an Internet of Things terminal provided by another embodiment of the present disclosure; and

FIG. 4 is a flow chart of an access method for an Internet of Things terminal provided by the embodiment of the present disclosure.

### DETAILED DESCRIPTION

The embodiments described in the present disclosure should not be regarded as limitations of the present disclosure, and all other embodiments obtained by those of ordinary skills in the art without going through any creative work should fall within the scope of protection of the present disclosure.

In the following description. “some embodiments” involved describe a subset of all possible embodiments, but it can be understood that “some embodiments” may be the same subset or different subsets of all possible embodiments, and may be combined with each other without conflict.

Unless otherwise defined, all technical and scientific terms used herein have the same meanings as those commonly understood by those of ordinary skills in the art. The terms used herein are only for the purpose of describing the embodiments of the present disclosure, and are not intended to limit the present disclosure.

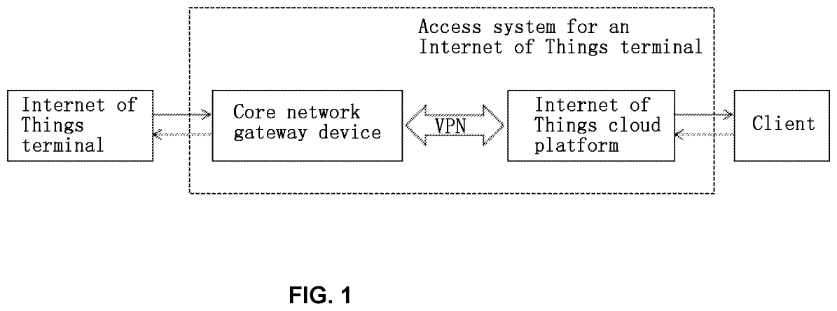

An embodiment of the present disclosure provides an access system for an Internet of Things terminal, and with reference to FIG. 1, the access system for an Internet of Things terminal comprises a core network gateway device and an Internet of Things cloud platform, wherein the core network gateway device and the Internet of Things cloud platform communicate with each other through a first virtual private network (first VPN). The core network gateway device is configured for allocating a first IP address to an Internet of Things terminal, establishing an Internet of Things terminal address pool according to the first IP address, and sending the Internet of Things terminal address pool to the Internet of Things cloud platform. The Internet of Things cloud platform is configured for receiving and storing the Internet of Things terminal address pool, when a first message of a downlink instruction is received, obtaining the first IP address according to the first message and the Internet of Things terminal address pool, and packaging the first message and the first IP address into a second message to be sent to the core network gateway device.

Specifically: the Internet of Things terminal sends a paging signal, which accesses a core network through a base station. The core network gateway device (also called a core network PGW device) allocates the first IP address to the Internet of Things terminal and establishes the Internet of Things terminal address pool according to the first IP address, wherein the first IP address is a private network address in an operator, and then establishes a session bearer with the Internet of Things terminal. The core network PGW device and the Internet of Things cloud platform communicate with each other through the first virtual private network, wherein the first virtual private network may be a CN2 (ChinaNet Next Carrying Network) VPN (Virtual Private Network). The VPN is established between the core network PGW device and the Internet of Things cloud platform, i.e., the core network PGW device and the Internet of Things cloud platform communicates with each other in a local area network, and the first IP address is not mapped into a public network address in the core network PGW device, that is, source address mapping is not carried out. The core network PGW device sends the Internet of Things terminal address pool to the Internet of Things cloud platform. A downlink instruction of a client, which is namely the first message, is sent to the Internet of Things cloud platform, the Internet of Things cloud platform can obtain the first IP address of the Internet of Things terminal to which the first message needs to be sent according to an Internet of Things terminal number in the first message and the Internet of Things terminal address pool, and the first message is routed to the corresponding Internet of Things terminal through the CN2 VPN. In the core network, a destination address of the first message does not need to be mapped into the private network address of the Internet of Things terminal, and the Internet of Things terminal does not need to send a heartbeat message at intervals to keep the mapping of a NAT session of the core network, which can reduce the occupation of terminal heartbeat data on wireless network resources, improve a network capacity, and reduce the power consumption of a terminal.

It can be understood that the second message comprises the first IP address, user instruction data and a second IP address of a virtual server of the Internet of Things cloud platform.

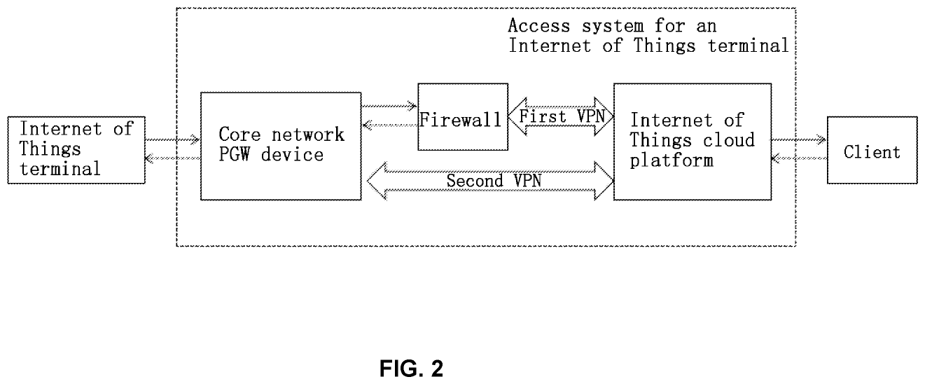

With reference to FIG. 2, according to some specific embodiments of the present disclosure, the access system for an Internet of Things terminal further comprises a firewall, and the core network gateway accesses the first virtual private network through the firewall. The firewall is a separator, a limiter and an analyzer, which effectively monitors any activity between the Intranet and the Internet, so that the core network PGW device does not carry out source network address mapping, thus improving the security of the Intranet.

According to some specific embodiments of the present disclosure, the access system for an Internet of Things terminal further comprises a core network address mapping device (also called a core network NET device). The core network NET device is configured for acquiring an uplink message of the Internet of Things terminal, parsing the uplink message to obtain the first IP address. Internet of Things data and a destination IP address, mapping the destination IP address into a second IP address, and packaging the first IP address, the Internet of Things data, the destination IP address and the second IP address into a third message.

It can be understood that the first IP address is an IP address of the Internet of Things terminal, the destination IP address is an address of the client, and the second IP address is a private IP address of the virtual server of the Internet of Things platform.

With reference to FIG. 2, according to some specific embodiments of the present disclosure, the core network gateway device communicates with the Internet of Things cloud platform through a second virtual private network (second VPN). The core network gateway device is further configured for generating a radius (remote authentication dial in user service) session message, and the radius session message is configured for characterizing a state of the Internet of Things terminal. The Internet of Things cloud platform is further configured for receiving the radius session message through the second virtual private network, and identifying the state of the Internet of Things terminal according to the radius session message. Specifically, when the Internet of Things terminal is attached to the network, the core network PGW device generates the radius session message, wherein the radius session message comprises IMEI, IMSI, an IP address, an attachment result and other contents of the Internet of Things terminal. After the radius session message is sent to the Internet of Things cloud platform, the Internet of Things cloud platform extracts a corresponding field in the radius session message to identify the state of the Internet of Things terminal, so as to realize online or offline detection of the Internet of Things terminal on the Internet of Things cloud platform.

According to some specific embodiments of the present disclosure, the access system for an Internet of Things terminal further comprises a core network user edge router (also called a core network CE device), the first virtual private network is the CN2 VPN, the core network user edge router is configured with a CN2 VPN network interface, and the core network gateway device accesses the CN2 VPN through the core network CE device. The core network CE device receives a virtual server address pool on the Internet of Things cloud platform through a BGP (Border Gateway Protocol), wherein the virtual server address pool comprises a plurality of second IP addresses.

In some embodiments, the access system for an Internet of Things terminal further comprises a cloud platform user edge router (also called a cloud platform CE device). The cloud platform user edge router receives the Internet of Things terminal address pool through the BGP, wherein the Internet of Things terminal address pool comprises a plurality of first IP addresses.

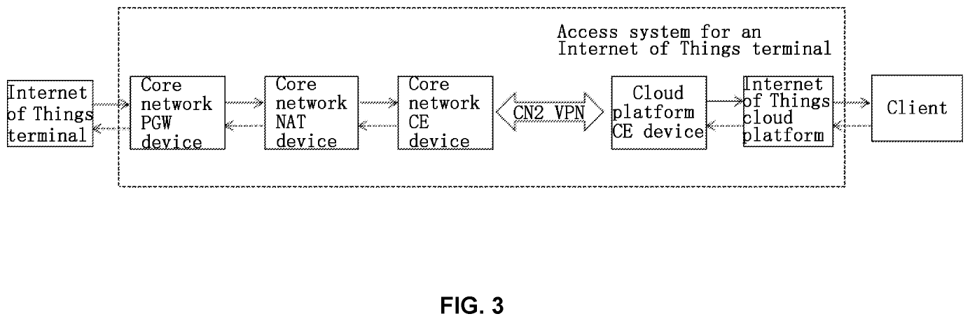

With reference to FIG. 3, in combination with specific implementation of the present disclosure, the access system for an Internet of Things terminal applied to a NB-IoT will be specifically described.

The core network PGW device receives a network access and attachment request of the Internet of Things terminal and establishes the session bearer, and allocates the first IP address to the Internet of Things terminal at the same time. Specifically, the Internet of Things terminal initiates the network access and attachment request, a provincial network forwards the network access and attachment request to the core network PGW device, and the core network PGW device establishes the session bearer for the Internet of Things terminal. The core network PGW device allocates a first IP address of one private network to the Internet of Things terminal, and a session bearer of the NB-IoT is always kept online. After network bearer interworking of the core network is realized through the established session bearer, the Internet of Things terminal starts to send a service data packet, which is namely the uplink messages, and the core network PGW device forwards the data packet to the core network NAT device. The core network PGW device generates the radius session message according to the network access and attachment request, and copies the radius session message to the Internet of Things cloud platform through the VPN network. Generally, the Internet of Things terminal needs to remain continuously powered on and awake to monitor a paging message of a wireless network in real time, so that when an instruction is issued, wireless resource control connection can be immediately established.

The core network NET device carries out destination network address mapping according to the destination IP address accessed by the Internet of Things terminal in the uplink message. Specifically, according to the destination IP address mapping carried out by the core network NAT device, the IP address of the client is mapped into the second IP address of the Internet of Things cloud platform, that is, a destination public network IP address is mapped into a private network IP address, and the first IP address of the Internet of Things terminal, which is namely a source IP address, is kept unchanged without any mapping.

The core network CE device receives the uplink message after completing the mapping of the network address by the core network NET device, and the core network CE device is uplinked to a local PE device to access the CN2 VPN. The core network CE device forwards the uplink message to the Internet of Things cloud platform through the CN2 VPN. Meanwhile, the core network CE device receives the private network IP address of the virtual server LVS of the Internet of Things cloud platform, which is namely the second IP address, through the BGP, so that the core network NET device carries out the destination IP address mapping. The virtual server (LVS) is configured for realizing an IP-based data request load balancing scheduling scheme, which can carry out data load balancing forwarding according to the source IP address.

The cloud platform CE device is connected to a local PE device of the Internet of Things cloud platform, the Internet of Things cloud platform accesses the CN2 VPN through the cloud platform CE device to receive the uplink message, and the Internet of Things cloud platform correspondingly forwards the uplink message to the client. In addition, the core network CE device announces the Internet of Things terminal address pool through the BGP, and the cloud platform CE device also announces the LVS address pool through the BGP.

The Internet of Things cloud platform receives the uplink message through the CN2 VPN, and forwards the uplink message to the client. The Internet of Things cloud platform further receives the radius session message through the VPN network to perceive a state of a terminating network. Specifically: the Internet of Things cloud platform uses the LVS as a service access point, the uplink message of the Internet of Things terminal is forwarded to a back-end CIG service (cloud plug in gateway) cluster through the LVS service, the CIG service may parse the source IP address of the uplink message, which is namely the first IP address, so as to realize corresponding management of the Internet of Things terminal, and the IP address is saved in a Redis persistent database. The CIG service of the Internet of Things cloud platform perceives an online state of the Internet of Things terminal through the radius message, and controls an occasion of instruction issuance, so that the instruction does not need to be issued when the Internet of Things terminal is not online.

In the case of data reporting, the network address mapping of the uplink message is carried out by the core network NAT device, the next hop of routing of the core network NAT device enters the CE device, the CE forwards message to the CN2 VPN, and the BGP discovers a routing address of an opposite terminal to complete uplink routing interworking. In the case of instruction issuance, the first message of the client is received, the first IP address of the Internet of Things terminal in the first message is discovered through the CIG service, the instruction is packaged into the second message of the downlink instruction, and then the second message is forwarded to the LVS. The LVS forwards the second message to the cloud platform CE device, and the second message reaches the core network CE device through the CN2 VPN. The core network CE device discovers the first IP address of the second message to realize downlink routing interworking.

In the embodiment of the present disclosure, the Internet of things terminal can keep terminal-to-terminal network communication without sending the heartbeat data through capability integration of the Internet of thing cloud platform and the Internet of things core network, and the Internet of Things terminal only needs to be in a state of monitoring the paging request of the wireless network to enable the arrival of the downlink instruction of the cloud platform service at any time, which can reduce the occupation of the heartbeat data of the terminal on wireless network resources, improve a network capacity; and reduce the power consumption of the terminal.

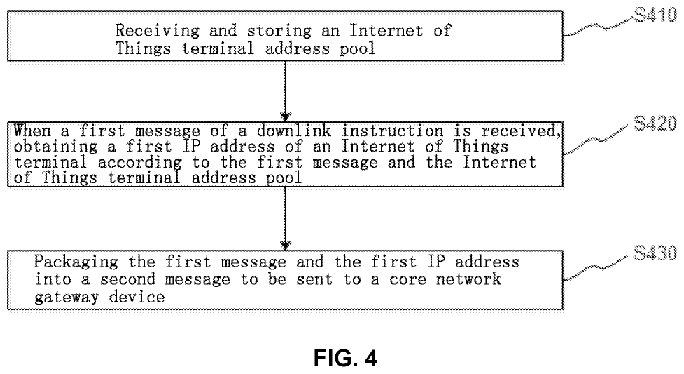

An embodiment of the present disclosure further provides an access method for an Internet of Things terminal, which is applied to the Internet of Things cloud platform of the access system for an Internet of Things terminal above. With reference to FIG. 4, the access method for an Internet of Things terminal comprises, but is not limited to, step S410, step S420 and step S430.

In step S410, the Internet of Things terminal address pool is received and stored.

In step S420, when the first message of the downlink instruction is received, the first IP address of the Internet of Things terminal is obtained according to the first message and the Internet of Things terminal address pool.

Specifically, the first message comprises a number identification of the Internet of Things terminal, and the Internet of Things cloud platform parses the number identification in the first message, and then matches the first IP address of the Internet of Things terminal from the Internet of Things terminal address pool according to the number identification.

In step S430, the first message and the first IP address are packaged into the second message to be sent to the core network gateway device.

In the embodiment, the downlink instruction of the client, which is namely the first message, is sent to the Internet of Things cloud platform, the Internet of Things cloud platform can obtain the first IP address of the Internet of Things terminal to which the first message needs to be sent according to the Internet of Things terminal number in the first message and the Internet of Things terminal address pool, and the first message is routed to the corresponding Internet of Things terminal through the CN2 VPN. In the core network, a destination address of the first message does not need to be mapped into the private network address of the Internet of Things terminal, and the Internet of Things terminal does not need to send a heartbeat message at intervals to keep the mapping of a NAT session of the core network, which can reduce the occupation of terminal heartbeat data on wireless network resources, improve a network capacity, and reduce the power consumption of a terminal.

An embodiment of the present disclosure further provides an Internet of Things terminal access apparatus, which comprises:
at least one processor; and
at least one memory for storing at least one program:
wherein the at least one program, when executed by the at least one processor, causes the at least one processor to implement the access method for an Internet of Things terminal.

The Internet of Things terminal access apparatus in the embodiment is applied to the Internet of Things cloud platform of the access system for an Internet of Things terminal, when the Internet of Things cloud platform receives the downlink instruction of the client, which is namely the first message, the Internet of Things cloud platform can obtain the first IP address of the Internet of Things terminal to which the first message needs to be sent according to the Internet of Things terminal number in the first message and the Internet of Things terminal address pool, and the first message is routed to the corresponding Internet of Things terminal through the CN2 VPN. In the core network, a destination address of the first message does not need to be mapped into the private network address of the Internet of Things terminal, and the Internet of Things terminal does not need to send a heartbeat message at intervals to keep the mapping of a NAT session of the core network, which can reduce the occupation of terminal heartbeat data on wireless network resources, improve a network capacity, and reduce the power consumption of a terminal.

An embodiment of the present disclosure further provides a computer-readable storage medium, wherein the computer-readable storage medium stores a computer-executable instruction, and the computer-executable instruction is executed by one or more control processors, for example, to executing the steps described in the above embodiment.

Those of ordinary skills in the art can understand that all or some of steps in the method, and the systems disclosed above can be implemented as software, firmware, hardware and appropriate combinations thereof. Some or all of the physical components can be implemented as software executed by a processor, such as a central processing unit, a digital signal processor or a microprocessor, or implemented as hardware, or implemented as an integrated circuit, such as an application-specific integrated circuit. Such software can be distributed on a computer-readable medium, and the computer-readable medium may include a computer storage medium (or a non-transitory medium) and a communication medium (or a transitory medium). It is well known to those of ordinary skills in the art that the term “computer storage medium” comprises a volatile and nonvolatile, removable and non-removable medium implemented in any method or technology for storing information (such as a computer readable instruction, a data structure, a program module, or other data). The computer storage medium includes but not limited to RAM, ROM. EEPROM, flash storage or other storage technologies. CD-ROM, digital versatile disk (DVD) or other optical disk storage, magnetic box, magnetic tape, magnetic disk storage or other magnetic storage devices, or any other medium that can be used to store desired information and accessed by a computer. Furthermore, it is well known to those of ordinary skills in the art that the communication medium typically includes a computer readable instruction, a data structure, a program module or other data in a modulated data signal such as a carrier wave or other transmission mechanism, and may include any information delivery medium.

The preferred embodiments of the present disclosure have been described in detail above, but the present disclosure is not limited to the embodiments above. Those of ordinary skills in the art may further make various equivalent modifications or substitutions without departing from the gist of the present disclosure, and these equivalent modifications or substitutions are all included in the scope defined by the claims of the present disclosure.

1. An access system for an Internet of Things terminal, comprising a core network gateway device and an Internet of Things cloud platform,
wherein the core network gateway device and the Internet of Things cloud platform communicate with each other through a first virtual private network;
wherein the core network gateway device is configured for allocating a first IP address to an Internet of Things terminal, establishing an Internet of Things terminal address pool according to the first IP address, and sending the Internet of Things terminal address pool to the Internet of Things cloud platform; and
wherein the Internet of Things cloud platform is configured for receiving and storing the Internet of Things terminal address pool, and when a first message of a downlink instruction is received, obtaining the first IP address according to the first message and the Internet of Things terminal address pool, and packaging the first message and the first IP address into a second message to be sent to the core network gateway device.

2. The access system for an Internet of Things terminal according to claim 1, further comprising a firewall, through which the core network gateway accesses the first virtual private network.

3. The access system for an Internet of Things terminal according to claim 1, further comprising a core network address mapping device configured for
acquiring an uplink message of the Internet of Things terminal,
parsing the uplink message to obtain the first IP address, Internet of Things data and a destination IP address,
mapping the destination IP address into a second IP address, and
packaging the first IP address, the Internet of Things data, the destination IP address and the second IP address into a third message.

4. The access system for an Internet of Things terminal according to claim 1, wherein the second message comprises the first IP address, user instruction data and a second IP address of a virtual server of the Internet of Things cloud platform.

5. The access system for an Internet of Things terminal according to claim 4, further comprising a core network user edge router, wherein the first virtual private network is a CN2 (Chinatelecom Next Carrier Network) VPN (Virtual Private Network), the core network user edge router is configured with a CN2 VPN network interface, and the core network gateway device accesses the CN2 VPN through the core network user edge router; and
wherein the core network user edge router is configured for receiving a virtual server address pool on the Internet of Things cloud platform through a BGP (Border Gateway Protocol), wherein the virtual server address pool comprises a plurality of second IP addresses.

6. The access system for an Internet of Things terminal according to claim 5, further comprising a cloud platform user edge router configured for receiving the Internet of Things terminal address pool through the BGP, wherein the Internet of Things terminal address pool comprises a plurality of first IP addresses.

7. The access system for an Internet of Things terminal according to claim 1, wherein the core network gateway device communicates with the Internet of Things cloud platform through a second virtual private network;
the core network gateway device is further configured for generating a radius (remote authentication dial in user service) session message, and the radius session message is configured for characterizing a state of the Internet of Things terminal; and
the Internet of Things cloud platform is further configured for receiving the radius session message through the second virtual private network, and identifying the state of the Internet of Things terminal according to the radius session message.

8. An access method for an Internet of Things terminal, applied to the Internet of Things cloud platform of the access system for an Internet of Things terminal, wherein the access method for an Internet of Things terminal comprises:
receiving and storing the Internet of Things terminal address pool;
when the first message of the downlink instruction is received, obtaining the first IP address of the Internet of Things terminal according to the first message and the Internet of Things terminal address pool; and
packaging the first message and the first IP address into the second message to be sent to the core network gateway device.

9. An Internet of Things terminal access apparatus, comprising:
at least one processor; and
at least one memory for storing at least one program;
wherein the at least one program, when executed by the at least one processor, causes the at least one processor to implement the access method for an Internet of Things terminal according to claim 8.

10. A non-transitory computer-readable storage medium, storing a program executable by a processor, wherein the program executable by the processor, when executed by the processor, implements the access method for an Internet of Things terminal according to claim 8.
